(19) United States
(12) Patent Application Publication
(10) Pub. No.: US 2003/0062474 A1
(43) Pub. Date: Apr. 3, 2003

(54) Electrospray ion source for mass spectrometry with atmospheric pressure desolvating capabilities

(76) Inventors: Vladimir I. Baranov, Richmond Hill (CA); Hassan Javaheri, (US); Thomas R. Covey, (US)

Correspondence Address: Bereskin & Parr, 40 King Street West, Box 401, Toronto, ON, M5H 3Y2, CA

(21) Appl. No.: 09/968,924

(22) Filed: Oct. 3, 2001

(51) Int. Cl. H01J 49/04

(52) U.S. Cl. 250/288

(57) ABSTRACT

An interface member plate is provided for use in a mass spectrometer system. It includes an orifice and a desolvation chamber which can be generally cylindrical and elongate. Moreover, the desolvation chamber can be heated to encourage desolvation of any remaining solvant. The orifice largely determines flow into low pressure downstream sections containing sections of the mass spectrometer. The desolvation chamber has a larger cross-section and its characteristic parameters can be set independently of the parameters of the orifice. The interface member can be provided directly downstream from an ion source, or separating an upstream curtain gas chamber from the low pressure mass analyzing sections of the mass spectrometer.

### FIELD OF THE INVENTION

This invention relates to mass spectrometry. This invention more particularly relates to the interface between an atmospheric ion source and low pressure regions of a mass spectrometer.

### BACKGROUND OF THE INVENTION

Samples or analytes for analysis in mass spectrometers are commonly provided dissolved in a suitable solvent. This provides advantages in handling of samples, but when the sample is to be ionized for analysis in a mass spectrometer, there is the problem of removing the solvent. One common ionization technique is electrospray and its derivatives, such as nanospray, which provides a low flow. In all such techniques, a liquid sample, containing the desired analyte in a solvent, is caused to form a spray of charged droplets at the tip of an electrospray capillary. Accordingly, an important step in generating ions is to ensure proper desolvation, i.e. the evaporation and removal of the solvent from the droplets. Proper desolvation improves signal to noise ratio, signal intensity and signal stability. The electrospray source is usually coupled with some means of desolvation in an atmospheric pressure chamber where desolvation can be enhanced by heat transfer to the droplets (radiation, turbulence) or/and counter flow of dry gas.

As the majority of mass spectrometers operate under reduced gas pressure (typically vacuum conditions of less than 10-4 Torr), there is the problem of transferring ions produced in the atmospheric pressure region into the low pressure chamber of the mass spectrometer, while ensuring adequate separation or rectification of ions from surrounding gas and solvent molecules (neutrals). This process can be roughly separated into three distinct regions, namely: liquid sample charging and its nebulization; transport of ions through an interface between atmospheric and low pressure chambers; and rapid expansion into the low pressure chamber. Correspondingly, the desolvation step can be performed: immediately after nebulization, for example as in Covey et al. U.S. Pat. No. 5,412,208 and Apffel, Jr. et al. U.S. Pat. No. 5,495,108; in the interface region, for example as disclosed in Allen et al. U.S. Pat. No. 5,015,845, Chowdhury et al. U.S. Pat. No. 4,977,320, Chait et al. U.S. Pat. No. 5,245,186, Henion et al. U.S. Pat. No. 4,935,624, and Bajic U.S. Pat. No. 5,756,994; or during expansion in the low pressure region, with the help of an electrostatic or RF field, for example as disclosed in conference abstract entitled “Ion transmission through a multi-capillary inlet and ion funnel interface” by Taeman Kim et al. from Abstracts of the ASMS 2000 Conference. Small translational energy is pumped by the RF field into the total ion energy between every collision preventing ions from cooling. Following collision, there is partial transfer of this energy into the internal energy of ions (clusters). If collisions are more frequent than the RF field cycle, overall effect will be cooling. If the RF field cycles several times between collisions, overall effect will be the step-by-step increase in the internal energy of ions/clusters with high probability for such ions to overcome a dissociation barrier.

In U.S. Pat. No. 5,756,994, a heated entrance chamber is provided, and is pumped separately. Ions enter this chamber through an entrance orifice, and are then sampled through an exit orifice that is located in the side of the chamber, off any line representing a linear trajectory from the entrance orifice, with the intention of providing for efficient removal of neutral solvent molecules. Pressure in this heated entrance chamber is maintained around 100 Torr. To the extent that this is understood, there is independent pumping arrangement in the entrance chamber, and the shape of the chamber is not conducive to maintaining laminar flow, with the entrance orifice being much smaller than the cross-section of the main portion of the chamber itself. It is expected that significant loss of ion current to the walls of this chamber would occur in addition to obvious inefficiency of sampling from only one point of cylindrical flow (trough the exit orifice).

In U.S. Pat. Nos. 4,977,320, 5,245,186 and 4,935,624, a heated tube made from conductive or non-conductive materials was used for delivering the ions/gas carrier/solvent flow into the low pressure chamber. In such a configuration, the heated tube provides two distinct and separate functions; firstly, due to its significant resistance to gas flow, the tube configuration, namely its length and diameter, adjusts the gas load on the pumping system; secondly, the tube can be heated to effect desolvation and separation of ions from neutrals. With respect to the first function, this resistance can be provided, while keeping the tube length constant, to ensure laminar gas flow in the tube and the widest possible opening for inhaling the ion/gas carrier/solvent flow. Generally, a wider bore for the tube provides increased gas flow and hence more load on the pumping system; correspondingly, reducing the tube length provides less resistance to the gas flow, so as also to increase the gas flow and load on the pumping system. These two geometric parameters, bore and length, are obviously related and can be adjusted to provide the desired flow rate and flow resistance. The second function is provided by mounting a heater around the interface tube. The heat provided to the tube promotes desolvation of the ion flow, and also helps to reduce contamination of the surface of the tube, thereby reducing memory effects. An interface of this sort is able to work only under strictly laminar flow conditions, limiting the variability of the tube length and tube bore. Additionally, the desolvation, which depends on temperature and residence time (inversely proportional to gas velocity through the tube) is related to the pumping requirements. As a rule, it is not possible to optimize all the desired parameters; in particular, it is desirable to minimize total mass flow to reduce pumping requirements, on the other hand to ensure best efficiency for transfer of ions into the mass spectrometer, a large diameter tube with high mass flow rates is desirable. However, it is generally opposite to the desolvation requirements.

### SUMMARY OF THE INVENTION

In accordance with the first aspect of the present invention there is provided an interface number, for use in a mass spectrometer between an ion source operating at a relatively high pressure and a lower pressure chamber, the interface member including:

An orifice, defining the minimum flow cross-section of the interface member; and a desolvation chamber having an elongate bore, in communication with the orifice, the bore having a larger cross-section than the orifice, whereby, in use, for a given pressure differential across the interface member, the orifice primarily determines the mass flow rate of gas through the interface member.

In accordance with the second aspect of the present invention, there is provided a mass spectrometer system comprising:

a ion source in a first chamber for operation at relatively high pressure;

an interface member;

at least one-second chamber maintained at a relatively low pressure and separated from the first chamber by the interface member;

a mass spectrometer within said at least one second chamber; and

a pump connected to said at least one-second chamber for maintaining the relatively low pressure therein;

Wherein the interface member includes an orifice and an elongate desolvation chamber that are within communication with one another, with the desolvation chamber having an inlet for receiving ions from the first chamber and the orifice opening into said at least one second chamber, and wherein the desolvation chamber has a larger cross-section than the orifice, whereby, in use, for a given pressure differential between the first and second chambers, the flow rate there between is primarily determined by the cross-section of the orifice.

Additionally, a third aspect of the present invention provides a method of analyzing an analyte, the method comprising:

providing the analyte as a liquid sample comprising the analyte dissolved in a solvent;

forming a spray of droplets of the liquid sample and promoting ionization of the analyte to form analyte ions, in a first chamber at a first pressure.

passing the analyte ions through a desolvation chamber having a first cross-section;

passing analyte ions through a orifice having a second cross-section smaller than the first cross-section, into at least one second chamber at a pressure lower than the first pressure; and

mass analyzing the ions.

### BRIEF DESCRIPTION OF THE DRAWINGS

For a better understanding of the present invention and to show more clearly how it may be carried into effect, reference will now be made, by way of example, to the accompanying drawings which show preferred embodiments of the present invention and in which:

FIG. 1 shows schematically a simple mass spectrometer incorporating an interface in accordance with the present invention;

FIG. 2 shows a triple quadrupole mass spectrometer incorporating an interface in accordance with the present invention;

FIG. 3 shows a QqTof mass spectrometer incorporating an interface according to the present invention;

FIG. 4 shows a cross-section through a first embodiment of an interface in accordance with the present invention;

FIG. 5 shows a cross-section through part of the interface of FIG. 4 and skimmers in accordance with the present invention;

FIG. 6 shows a cross-section through a second embodiment of an interface in accordance with the present invention;

FIG. 7 shows a schematic cross-section of a further embodiment of an interface in accordance with the present invention;

FIG. 8 shows schematic cross-sectional view of another interface in accordance with present invention; and

FIGS. 9, 10, and 11 show graphs showing variation of of ion signals under different operating conditions.

### DETAILED DESCRIPTION OF THE INVENTION

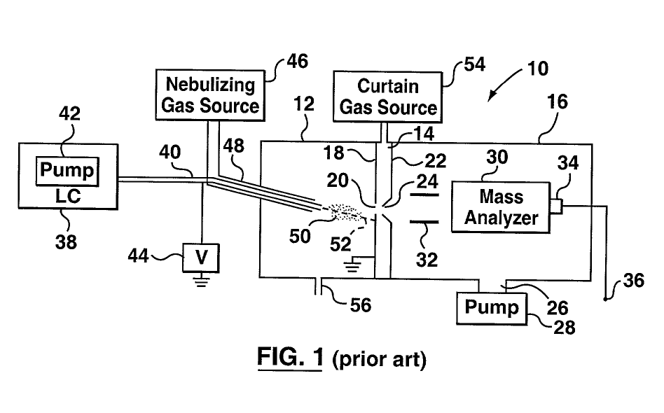

Reference is first made to FIG. 1 which shows diagrammatically a prior art nebulizer gas spray analyzer 10 generally as shown in U.S. Pat. No. 4,861,988. The analyzer 10 includes an atmospheric pressure ionization chamber 12, a gas curtain chamber 14, and a vacuum chamber 16. The ionization chamber 12 is separated from the gas curtain chamber 14 by an orifice plate 18 containing an inlet orifice 20. The gas curtain chamber 14 is separated from the vacuum chamber 16 by an outlet plate 22 containing an orifice 24.

The vacuum chamber 16, which is evacuated through outlet 26 by pump 28, contains a commercially available mass analyzer 28 (for example, a tandem triple quadrupole mass spectrometer as detailed below). Ions from ionization chamber 12 are drawn through orifices 20, 24 and are focused by ion lens elements 26 into analyzer 30. A detector 34 at the end of the analyzer 30 detects ions, which pass through the analyzer, and supplies a signal at terminal 36 indicative of the number of ions per second, which are detected.

The liquid sample to be analyzed is typically supplied from a liquid chromatograph (LC) 38 through capillary tube 40 into chamber 12. The flow rate of the liquid through capillary tube 40 is determined by an LC pump 42. The portion of capillary tube 40 which enters chamber 12 is made of a conductive material and has one pole (depending on the polarity of the ions desired) of a voltage source 44 connected to it. The other pole of source 44, and plate 18, are grounded. A source 46 of pressurized gas (e.g. nitrogen) supplies a sheath tube 48 coaxial with and encircling capillary 40 with a high velocity nebulizing gas flow which nebulizes fluid ejected from capillary 40. The mist of droplets 50 formed is carried toward the orifice 20 by the nebulizing flow. The droplets 50 are charged by the voltage applied to capillary 40, and as the droplets evaporate, ions are released from them and are drawn toward and through the orifices 20, 24.

As is conventional, the axis 52 of capillary 40 is aimed slightly off axis, i.e. slightly below the orifice 20. Thus, large droplets, which do not fully evaporate by the time they reach orifice 20, simply impact against the plate 18 and run down the plate where they are collected (by means not shown). Ions released from the fine droplets, which have evaporated, are drawn through the orifices 20, 24 into the vacuum chamber 16, where they are focused into the analyzer 30. As is well known, a curtain gas (typically nitrogen) from curtain gas source 54 diffuses gently out through orifice 20, i.e., there is a small pressure differential across the orifice plate 18, to prevent contaminants in chamber 12 from entering the vacuum chamber 16. Excess gas leaves chamber 12 via outlet 56.

It will be understood that while FIG. 1 shows a nebulizing gas flow including the high velocity gas flow through the sheet tube 48, this is not essential. Various ion sources are known which do not require a nebulizing source. Electrospray emitters that operate without the use of nebulizing gas can be used as sources of ions for this interface. In particular, electrospray sources that ionize liquid flows in the nanoliter to low microliter per minute range operate with a substantial advantage with the interface of the present invention which serves as the means of transferring the ions from the emitter droplet cloud into the vacuum system. The heated chamber serves several purposes with these low flow emitters. First it confines the gas being drawn into the vacuum chamber to the region immediately surrounding the low flow electrospray emitter serving to assist the electrospray charged droplet generation process. Second the heated portion of the chamber assists droplet desolvation and ion declustering. Third the gas confining properties of the chamber guide the dispersing spray cloud toward the ion entrance aperture substantially improving the efficiency of ion transfer into the vacuum system. These combined effects result in the maintenance of a stable generation of ions from this type of emitter over a broad flow range (low nanoliter to low microliter per minute range) and widely varying solvent compositions with substantially different surface tension properties. Electrospray emitters spraying solvents composed of 100% water or 100% organic solvent generate ion currents with equal efficiency and stability when they are operated in conjunction with the interface of the present invention.

Other types of ion sources operating at atmospheric pressure also may serve as sources of ions to be transferred into the vacuum system with the interface of the present invention, demonstrating its versatility. Atmospheric pressure chemical ionization (APCI), atmospheric pressure photoionization (APPI), and sources that produce ions as the result of other forms of energy input into the sample such as laser desorption and the related technique of matrix assisted laser desorption ionization (MALDI) are examples some of the ionization methods that benefit from the new ion transfer device of the present invention.

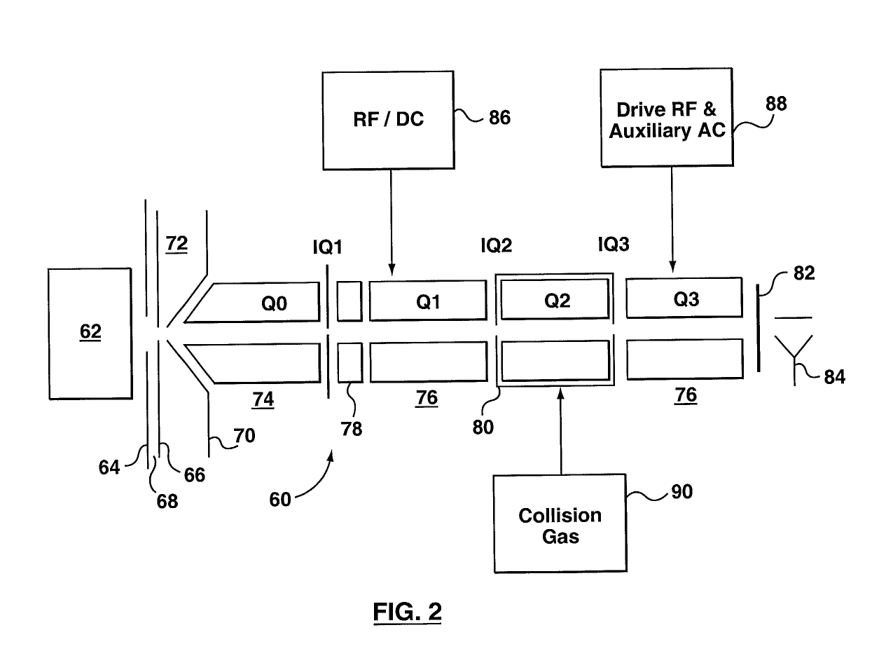

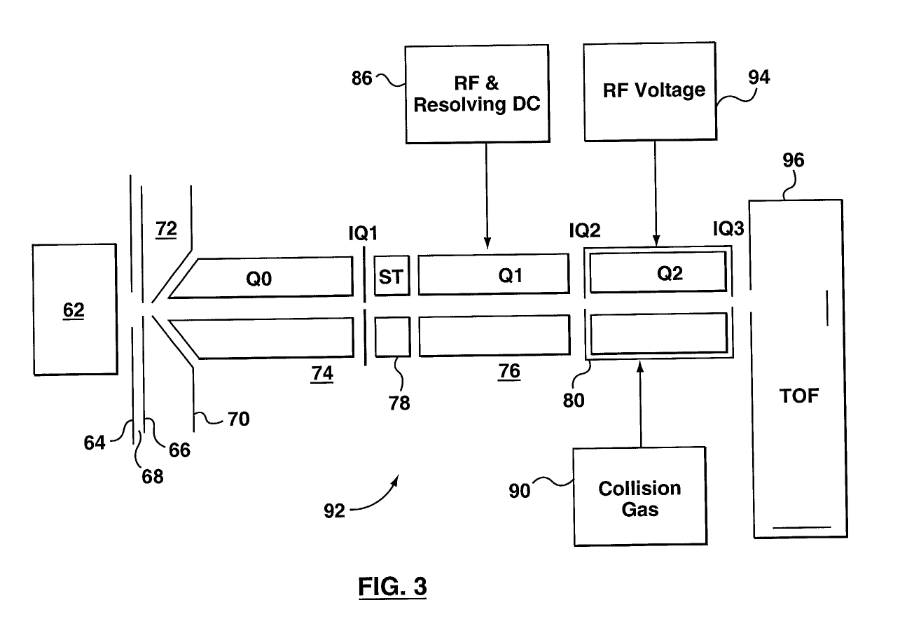

Also, FIG. 1 shows, schematically, a mass analyzer indicated at 30. It will be understood by a person skilled in this art that this mass analyzer 30 can be any suitable mass analyzer or mass spectrometer, and in particular any such instrument that necessarily operates under high vacuum conditions and therefore requires and interface between the atmospheric pressure ion source and the high vacuum conditions of the mass spectrometer. Specific examples of a triple quadurople mass spectrometer and a QqTOF instrument are detailed below in relations to FIGS. 2 and 3, and the invention can also be applied to ion trap mass spectrometers, Fourier Transform Ion Cyclotron Resonance (FTICR) mass spectrometers, magnetic sector mass spectrometer or 3D quadrupole ion trap mass spectrometer.

In accordance with the present invention, the orifice plate 18 would be replaced by a combination of an interface plate or member in accordance with the present invention, and, an upstream curtain plate, with the curtain chamber then located upstream of the interface member. The chamber 14 would then form an intermediate pressure chamber as in FIGS. 2 and 3.

Referring to FIG. 2, there is shown a conventional triple quadrupole mass spectrometer apparatus generally designated by reference 60. An ion source 62, for example an electrospray ion source, generates ions directed towards a curtain plate 64. Behind the curtain plate 64, there is an orifice plate 66, defining an orifice, in known manner.

A curtain chamber 68 is formed between the curtain plate 66 and the orifice plate 66, and a flow of curtain gas reduces the flow of unwanted neutrals into the analyzing sections of the mass spectrometer.

Following the orifice plate 66, there is a skimmer plate 70. An intermediate pressure chamber 72 is defined between the orifice plate 66 and the skimmer plate 20 and the pressure in this chamber is typically of the order of 2 Torr.

Ions pass through the skimmer plate 70 into the first chamber of the mass spectrometer, indicated at 74. A quadrupole rod set Q0 is provided in this chamber 74, for collecting and focusing ions. This chamber 74 serves to extract further remains of the solvent from the ion stream, and typically operates under a pressure of 7 mTorr. It provides interface into the analyzing sections of the mass spectrometer.

A first interquad barrier or lens IQ1 separates the chamber 74 from the main mass spectrometer chamber 76 and has an aperture for ions. Adjacent the interquad barrier IQ1, there is a short “stubbies” rod set, or Brubaker lens 78.

A first mass resolving quadrupole rod set Q1 is provided in the chamber 76 for mass selection of a precursor ion. Following the rod set Q1, there is a collision cell of 80 containing a second quadrupole rod set Q2, and following the collision cell 80, there is a third quadrupole rod set Q3 for effecting a second mass analysis step.

The final or third quadrupole rod set Q3 is located in the main quadrupole chamber 76 and subjected to the pressure therein typically 1×10⁻⁵ Torr. As indicated, the second quadrupole rod set Q2 is contained within an enclosure forming the collision cell 80, so that it can be maintained at a higher pressure; in known manner, this pressure is analyte dependent and could be 5 mTorr. Interquad barriers or lens IQ2 and IQ3 are provided at either end of the collision cell of 80.

Ions leaving Q3 pass through an exit lens 82 to a detector 84. It will be understood by those skilled in the art that the representation of FIG. 2 is schematic, and various additional elements would be provided to complete the apparatus. For example, a variety of power supplies are required for delivering AC and DC voltages to different elements of the apparatus. In addition, a pumping arrangement or scheme is required to maintain the pressures at the desired levels mentioned.

As indicated, a power supply 86 is provided for supplying RF and DC resolving voltages to the first quadrupole rod set Q1. Similarly, a second power supply 88 is provided for supplying drive RF and auxiliary AC voltages to the third quadrupole rod set Q3, for scanning ions axially out of the rod set Q3. A collision gas is supplied, as indicated at 90, to the collision cell 80, for maintaining the desired pressure therein.

The apparatus of FIG. 2 is based on an Applied Biosystems/MDS SCIEX API 2000 triple quadrupole mass spectrometer. In accordance with the present invention, an interface member or plate with a desolvation chamber would be substituted for the orifice plate 66 of FIG. 2.

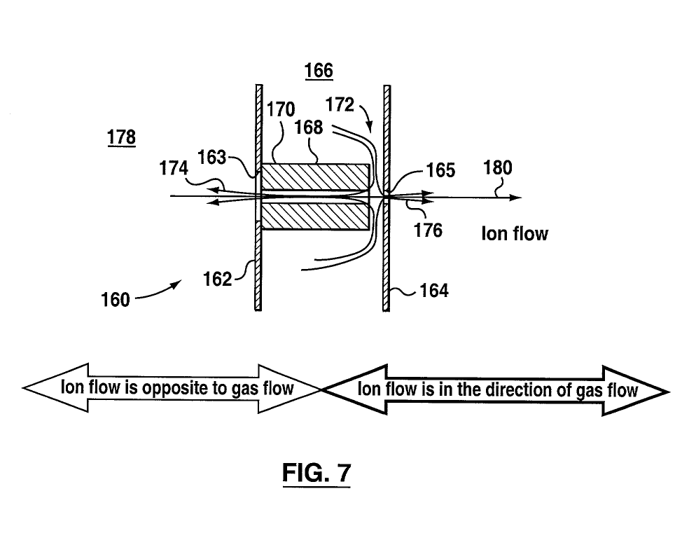

Another example of the application of the interface member of the present invention is shown in FIG. 3, which shows a QqTOF configuration, where in effect the final mass analyzer of a triple quadrupole is replaced with a Time of Flight (TOF) section. For simplicity like components in FIG. 3 are given the same reference as in FIG. 2 and the description of these components is not repeated. The Q-q-time-of-flight (TOF) tandem mass spectrometers shown in FIG. 7 (Q designating a mass analysis section and q a collision cell), is generally indicated at 92.

Precursor ions are mass selected in Q1 and then subject to one of the collision and reaction in Q2, within the collision cell 80. The resultant product ions and any remaining pressure ions are then mass analyzed in a Time of Flight (TOF) section 96. As indicated at 94, an RF power supply is provided for the collision cell 80, and although not shown in FIG. 2, this power supply would be provided in the triple quadrupole configuration as well.

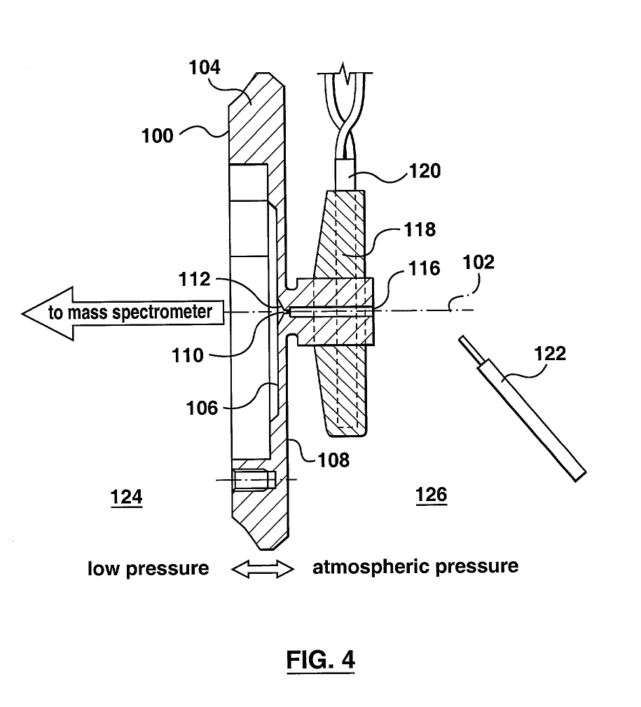

Reference will now be made to FIGS. 4, 5 and 6, which show different embodiments with the interface in accordance with the present invention. Each interface can replace the orifice plate variously indicated at 18 and or 66 in FIGS. 1-3. It is first to be noted that, when the interface plate of the present invention is used, it is, in general, optional whether the curtain gas is provided. In general, with nano-electrospray, where there are low desolvation requirements, the gas curtain is not essential. It is more desirable to use a gas curtain, with high flow sources, where there is a greater flow of neutrals, contaminants and the like, which is desired to keep out of the mass spectrometer.

Referring now to FIG. 4, this shows an interface 100, in accordance with the present invention. The interface 100 has a generally cylindrical cross-section throughout, i.e. it is formed as a body of revolution about its central axis 102. It includes a relatively thick outer portion 104 and a thin, plate-like central portion 106, with only a portion 108 of intermediate thickness there between. The interface plate 100 provides the function of the orifice plate 18.

An orifice 110 is provided centrally in the inner portion 106, on the axis 102, and as shown, a conical face 112 is provided on the low pressure side of the interface plate 100.

On the atmospheric pressure side, a cylindrical body 114 is provided extending axially out from the orifice 110 and defining a cylindrical desolvation chamber 116. Around the cylindrical desolvation chamber 116, there is a heater body 118, which is also generally cylindrical. A heater element is indicated at 120.

A sprayer for generating ions is indicated at 122. As noted above, this can be any suitable sprayer, for example an electrospray, nanospray, etc.

Here, the desolvation chamber 116 has a larger diameter than the orifice 110, and is dimensioned to ensure that there is laminar flow.

In the case where there is no curtain gas, the intermediate pressure region of the mass spectrometer is typically at a pressure of 2 Torr. Due to the high pressure differential from the atmospheric pressure chamber 126 to the low pressure chamber 124, a supersonic flow jet is created through the orifice 110. As is known, the mass flow of such a supersonic jet depends solely on the upstream pressure. In the present case, with the desolvation chamber 116 having a relatively large diameter compared to the orifice 110, the gas velocity through the desolvation chamber 116 is low and there is negligible pressure drop across the length of the desolvation chamber 116. Consequently, flow through the nozzle 110 is, effectively, determined by the exact pressure of the chamber 126 and the diameter of the orifice 110.

This gives the advantage that the properties of the orifice 110 and the desolvation chamber 116 can be separately determined and optimized. The diameter to the orifice 110 is set depending upon the acceptable pumping requirements and desired ion flow into the mass spectrometer.

Contrary, for example, to U.S. Pat. Nos. 4,977,320, 5,245,186 and 4,935,624, increasing the diameter of the desolvation chamber 116 will not increase the mass flow; instead, as the mass flow is determined by the orifice 110, increasing the diameter of the desolvation chamber 116 will reduce the flow velocity through chamber 116. It is generally favorable for the desolvation process to increase the residence time of ions in the desolvation chamber. It can be noted that as the gas is heated in the desolvation chamber 116, this will have the effect of reducing the gas density, for a given pressure, which theoretically will reduce the mass flow rate of gas into the low pressure chamber 124. The effect of this is expected to be small.

Thus, the interface functions are separated, as compared to earlier proposals, and this enabled the orifice function, determining the mass flow rate, and the desolvation function to be configured separately.

It can be shown that the power P required to heat gas (disregarding the droplet population) in the cylindrical desolvation chamber 116 from a temperature T to a temperature To is independent from the geometry (length and bore) of the desolvation chamber 116, and it is determined by:

P=T_{c}Aₒcₚ(Tₒ−T)

Where T_{c} is the continuum mass flux per unit area in the orifice 110, Aₒ is the orifice (nozzle, sample) area, cₚ is specific heat at constant pressure. For a nitrogen curtain gas flow, the orifice diameter was 0.25 mm and Tₒ=500K we have P=1.9W.

The geometry is particularly important for keeping laminar flow. Below a Reynolds number of 2300 one is fairly certain that the flow is laminar. For a desolvation chamber 116 of 1 cm length and 1 mm bore the nitrogen flow speed inside the desolvation chamber is equal to 10.2 m/s, residence time 0.98 ms, and the Reynolds number is 676, where the Reynolds number is determined from the tube (desolvation chamber) diameter.

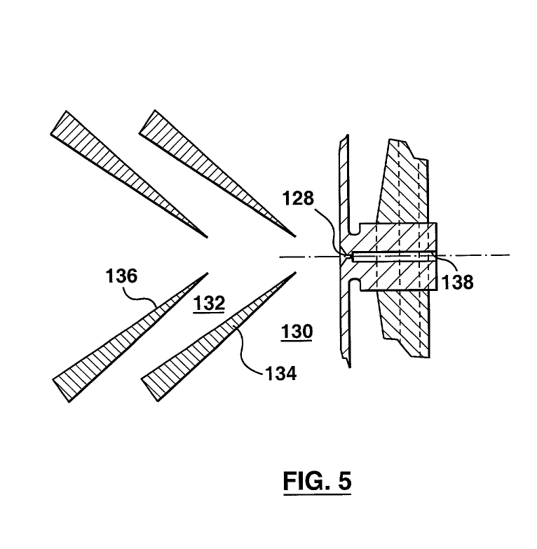

Similarly, the desolvation chamber 116 can be designed for a larger interface orifice 128, which is appropriate for a multi stage interface as depicted in FIG. 5. In this embodiment, chambers 130, 132 between the orifice 128 and a skimmer 134, and between the skimmer 134 and reducer 136 are pumped separately allowing significant increase in orifice size. For a 0.6 mm orifice, a curtain gas flow of nitrogen, and To=500K, we have P=10.6W. The desolvation chamber is here indicated at 138 and is 2 cm long and has a 3 mm bore on diameter, giving a flow speed inside the desolvation chamber 138 equal to 6.3 m/s, a residence time of 1.6 ms, and a Reynolds number of 1258. Therefore, the geometry of the desolvation chamber is separated from the gas load on the pumping system of mass spectrometer and can be selected based on different considerations. For example, compatibility of an electrospray needle, Taylor cone, or size of nebulized droplet flow with the chamber bore. It can be done with the purpose to “inhale” the entire droplet population from the ion source into the desolvation chamber. To prevent contamination and turbulent losses the Reynolds number should be below 2300. Turbulent flow promotes diffusion of ions to wall of chamber and hence deposition of ions on the chamber walls. Also, turbulent flow is inherently unstable and affects gas dynamics. As an additional benefit, keeping the desolvation chamber bore much bigger than a needle, used for generating electrospray etc., relaxes requirements for precise positioning of interface parts.

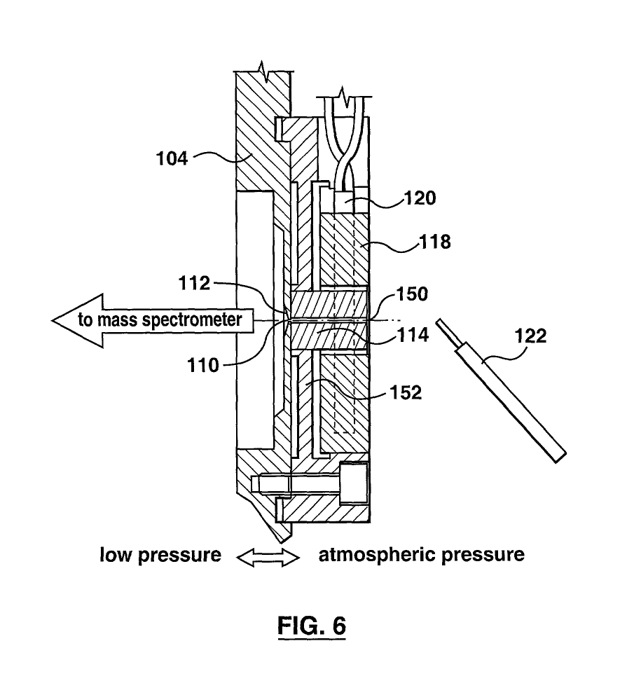

A further embodiment of the invention is disclosed in FIG. 6. This embodiment includes different materials for the desolvation chamber. Otherwise, for simplicity and brevity, like components in FIG. 6 are given the same reference as in earlier Figures.

In FIG. 6, the desolvation chamber is indicated at 150, and is made from resistive ceramic which is held in place be insulating ceramic insert 152. In this case an axial electric field between entrance of the desolvation chamber and interface orifice can be created, which should assist in ion drift through the chamber bore. This is achieved by providing a potential between the ends of the ceramic insert 152.

Reference is made to FIG. 7, which shows a further embodiment to the present invention, generally designated by the reference 160. This shows just a curtain plate at 162 and a nozzle or orifice plate 164, defining a curtain gas chamber 166. It will be understood that these elements would be introduced to a mass analyzer of FIG. 1, 2, or 3 in known manner, or into any other suitable mass analyzer. The curtain plate 162 includes a relatively large opening or orifice 163, while the orifice plate 164 includes an orifice 165.

In accordance with the present invention, a desolvation chamber 168 is provided, mounted on the inner surface of the curtain gas plate 162. The desolvation chamber 168 has a bore 190 having a diameter less than that of the opening orifice 163 while being significantly larger than the orifice 165. As shown, a small spacing or gap 172 is left between the desolvation chamber 168 and the orifice plate 164. This enables curtain gas to flow from the chamber 166 as indicated by the arrows 174 through the bore 170 into an upstream atmospheric pressure chamber 178 containing the ion source (not shown). Curtain gas also flows as indicated by arrows 176 through the orifice 165 into lower pressure downstream chambers of a mass spectrometer.

The ion beam is indicated at 180. Consequently, curtain gas flows countercurrent to the ion beam 180 through the desolvation chamber 168, and in the same direction as the ion beam through the orifice 165.

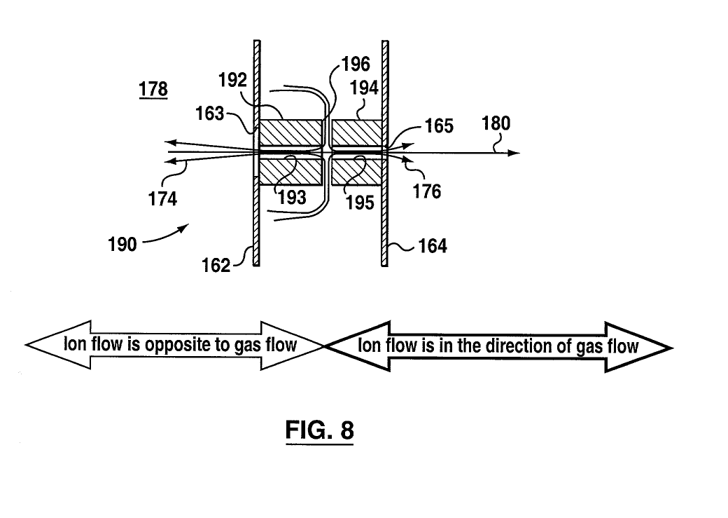

Reference will now be made to FIG. 8, which shows a further embodiment, comparable to that of FIG. 7. For simplicity and brevity, like components are given the same reference numeral in FIG. 8 and the description of these components is not repeated.

Here, the interface arrangement as a whole is indicated at 190, and the desolvation chamber is provided as first and second desolvation chambers 192 and 194. The desolvation chamber 192 is mounted on the curtain plate 162, comparable to the arrangement in FIG. 7. The second desolvation chamber 194 is mounted to the orifice plate 164. The desolvation chambers 192, 194 have respective bores 193, 195 that are axially aligned and, as before, are aligned with the orifices 163,165. A gap 196 is left between the first and second desolvation chambers 192,194.

As in FIG. 7, this enables curtain gas to flow both countercurrent and co-current with the ion beam again indicated at 180. Arrows 174 again indicates the flow of curtain gas countercurrent to the ion beam 180, through the bore 193 of the desolvation chamber 192 into the upstream ion source chamber 178. Additionally, the curtain gas flows in the same direction as the ion beam 180 as indicated by arrows 176, through the second desolvation chamber 194 and the orifice 185 into downstream low pressure chambers.

It is to be appreciated that various configurations of the desolvation chambers are possible. Thus, while the desolvation chambers 168 and 192 in FIGS. 7 and 8 are shown as mounted in the curtain gas chamber, it is conceivable that they could be mounted on the other side of the curtain gas plate 162, i.e., in the atmospheric pressure chamber 178. Alternatively, such a desolvation chamber could be mounted extending through the curtain gas plate, so that part of it is in the chamber 178 and another part of it in chamber 166.

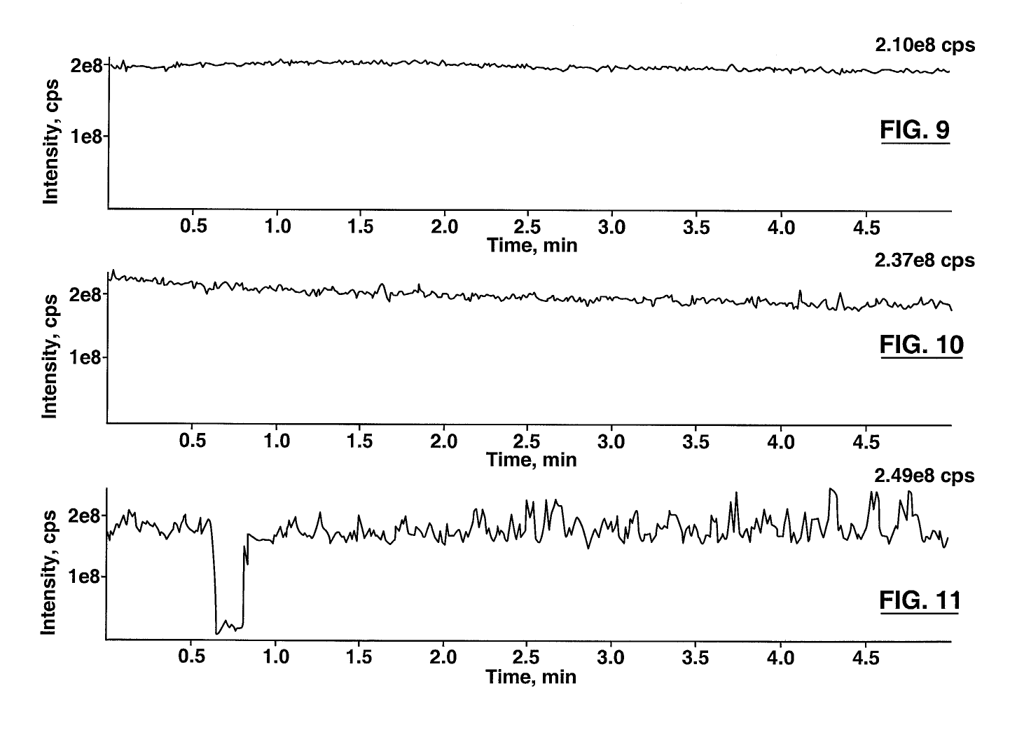

Referring to FIGS. 9, 10, and 11, they show test results obtained utilizing the interface chamber of FIG. 4. These graphs show the measurement utilizing a standard solution generated by using an electrospray type source. The ion intensity was measured in the mass range 35 to 800, and as shown, is indicated in counts per second, as measured over an interval of approximately 5 minutes.

FIG. 9 shows the result obtained when a curtain gas of nitrogen was applied and heat was also applied to the desolvation chamber. This shows a steady, uniform signal at around 2.0×10⁸ counts per second. FIG. 10 shows the results obtained when heat was provided but no curtain gas was supplied. While the initial signal is slightly stronger, this falls off significantly, and it can be noted that the signal level shows much greater variation in noise. Finally, FIG. 11 shows the results obtained when no heat and no curtain gas were supplied. As can be seen the signal fluctuates significantly, and the average intensity was reduced. These figures clearly show that providing both a heated desolvation chamber and a curtain gas provides a steady, constant signal level.

While the desolvation chamber has been described as being cylindrical, it is to be appreciated that further configurations are possible. For example, the desolvation chamber need not necessarily have a cylindrical cross-section. It is possible that both the desolvation chamber and the orifice could be, to at least some extent, slit-shaped or elongate in cross-section. Additionally, it is possible that the cross-section of the desolvation chamber could taper downwards from the inlet to the orifice. This should enable more available ions to be inhaled into the desolvation chamber. In such a case, it is expected that care would be need to be taken to ensure that the gas flow is not accelerated excessively as the cross-section of the desolvation chamber narrows or reduces since such acceleration may promote unwanted turbulence.

What is claimed is:

1. An interface member, for use in a mass spectrometer between an ion source operating at a relatively high pressure and a lower pressure chamber, the interface member including:
an orifice, defining the minimum flow cross-section of the interface member; and a desolvation chamber having an elongate bore, in communication with the orifice, the bore having a larger cross-section than the orifice, whereby, in use, for a given pressure differential across the interface member, the orifice primarily determines the mass flow rate of gas through the interface member.

2. An interface member as claimed in claim 1, wherein each of the orifice and the desolvation chamber has a circular cross-section, and wherein the orifice and the desolvation chamber are co-axial with one another.

3. An interface member as claimed in claim 2, wherein the desolvation chamber is generally cylindrical.

4. An interface member as claimed in claim 2 or 3, which includes a heater for the desolvation chamber.

5. An interface member as claimed in claim 4, wherein the interface member includes a central plate-like portion defining the orifice, and integral therewith, a cylindrical body defining the desolvation chamber.

6. An interface member as claimed in claim 5, which includes the heater body that is generally annular, around the cylindrical body defining the desolvation chamber, and including the heater mounted within the heater body.

7. An interface member as claimed in claim 2 or 3 which includes a desolvation body, defining the desolvation chamber and formed from a resistive material, to enable an axial field to be generated along the desolvation chamber, for promotion of movement of ions.

8. An interface member as claimed in claim 7, wherein the desolvation body is formed from a resistive ceramic, wherein the interface member includes a plate-like portion defining the orifice, and wherein an insolating ceramic insert mounts the desolvation body to the plate-like portion.

9. An interface member as claimed in claim 8, which includes a heater body and a heater within the heater body mounted around the desolvation body.

10. A mass spectrometer system comprising:
a) a ion source in a first chamber for operation at relatively high pressure;
b) an interface member;
c) at least one second chamber maintained at a relatively low pressure and separated from the first chamber by the interface member;
d) a mass spectrometer within said at least one second chamber; and
e) a pump connected to said at least one second chamber for maintaining the relatively low pressure therein; wherein the interface member includes an orifice and an elongate desolvation chamber that are within communication with one another, with the desolvation chamber having an inlet for receiving ions from the first chamber and the orifice opening into said at least one second chamber, and wherein the desolvation chamber has a larger cross-section than the orifice, whereby, in use, for a given pressure differential between the first and second chambers, the flow rate there between is primarily determined by the cross-section of the orifice.

11. A mass spectrometer system as claimed in claim 10, which includes a skimmer, an intermediate pressure chamber defined between the skimmer and the interface member, with the intermediate pressure chamber being located between said first chamber and said at least one second chamber, wherein the intermediate pressure chamber is connected to the pump means for being maintained at a pressure intermediate the pressure in the first chamber and the pressure in said at least one second chamber.

12. A mass spectrometer system as claimed in claim 11, wherein the mass spectrometer comprises a triple quadrupole mass spectrometer including first, second and third quadrupole rod sets, and wherein said at least one second chamber comprises a second chamber housing the first and third quadrupole rod sets, and a collision cell defining a third chamber including the second quadrupole rod set for effecting at least one of collision and reaction of ions, wherein a supply of collision gas is connected to the collision cell and the pump means is connected to said second chamber, and wherein power supplies are connected to the first, second and third quadrupole rod sets, for supplying focusing and resolving voltages.

13. A mass spectrometer system as claimed in claim 11, wherein the mass spectrometer comprises a first mass resolving rod set, a second rod set for effecting at least one of collision and reaction of ions, and a time of flight mass analysis section, and wherein said at least one second chamber comprises a second chamber housing the first quadrupole rod set, a third chamber housing the second rod set and including an inlet for one of a reaction gas and a collision gas, and time of flight drift tube.

14. A mass spectrometer as claimed in claims 10, 11, 12, and 13, which includes a curtain plate provided upstream of the interface member and defining a curtain chamber between the first chamber and said at least one second chamber and a supply of curtain gas connected to the curtain chamber, the curtain plate including a curtain orifice, whereby ions pass from the first chamber through the curtain orifice, through the curtain chamber and through the first orifice into said at least one second chamber.

15. A method of analyzing an analyte, the method comprising:
a) providing the analyte as a liquid sample comprising the analyte dissolved in a solvent;
b) forming a spray of droplets of the liquid sample and promoting ionization of the analyte to form analyte ions, in a first chamber at a first pressure.
c) passing the analyte ions through a desolvation chamber having a first cross-section;
d) passing analyte ions through a orifice having a second cross section smaller than the first cross-section, into at least one second chamber at a pressure lower than the first pressure; and
e) mass analyzing the ions.

16. A method as claimed in claim 15, which includes forming ions by one of electrospray and nanospray, atmospheric pressure chemical ionization atmospheric pressure photo ionization.

17. A method as claimed in claim 15, which includes heating the desolvation chamber to promote vaporization of remaining solvent and release of analyte ions from droplets.

18. A method as claimed in claim 15, which includes subjecting the analyte ions to a first mass analysis step to select a precursor ion, subjecting the precursor ion to one of reaction and collision to generate product ions, and mass analyzing the product ions.

19. A method as claimed in claim 18, which includes mass analyzing the product ions in one of a scanning mass analyzer including a rod set and a time of flight mass spectrometer.

20. A method as claimed in claim 15, which includes passing the analyte ions first through a curtain orifice and in curtain plate into a curtain chamber, supplying curtain gas to the curtain chamber whereby curtain gas flows out through the curtain orifice and through the desolvation chamber and the first orifice, whereby analyte ions and curtain gas flow together through the desolvation chamber and the first orifice into said at least one second chamber.

21. A method of analyzing an analyte, the method comprising:
a) providing analyte as a solid sample comprising at least the analyte;
b) forming ions by ionization of the sample in a first chamber at first pressure;
c) passing the analyte ions through a desolvation chamber having a first cross-section;
d) passing analyte ions through a orifice having a second cross section smaller than the first cross-section, into at least one second chamber at a pressure lower than the first pressure; and
e) mass analyzing the ions.

22. A method as claimed in claim 21, wherein step (b) comprises irradiating the sample with a laser beam, to effect laser desorption.

23. A method as claimed in claim 22, which includes providing the solid sample with a matrix material, selected to promote laser desorption of the solid sample.
